(19) United States
(12) Patent Application Publication
(10) Pub. No.: US 2025/0367960 A1
(43) Pub. Date: Dec. 4, 2025

(54) Adjustable Dry Erase Board for Vehicle Use

(71) Applicant: Fehlandt Lentini, Santa Rosa, CA (US)

(72) Inventor: Fehlandt Lentini, Santa Rosa, CA (US)

(21) Appl. No.: 19/006,343

(22) Filed: Dec. 31, 2024

Related U.S. Application Data
(60) Provisional application No. 63/654,159, filed on May 31, 2024.

(51) Int. Cl. B43L 1/00; B60R 11/00

(52) U.S. Cl. CPC B43L 1/008; B60R 11/00; B60R 2011/0008

(57) ABSTRACT

The present invention is a compact and portable dry erase board device designed for use in vehicles to facilitate easy note-taking. The device comprises a frame housing an erasable writing surface and a writing instrument that is removably stored in a retaining channel on the frame. The device is mounted on a vehicle's air conditioning (A/C) vent via a rubber sleeve that securely grips the slats. A metal ball joint enables for rotational and angular adjustment of the board and a threaded cap locks the board in place. A magnetic base provides quick attachment and detachment of the device from the A/C or heater vent. In one embodiment, the device includes an illumination source for low-light conditions and a wireless communication module for transmitting notes to a paired mobile device.

### CROSS-REFERENCE TO RELATED APPLICATION

The present application claims priority to, and the benefit of, U.S. Provisional Application No. 63/654,159, which was filed on May 31, 2024, and is incorporated herein by reference in its entirety.

### FIELD OF THE INVENTION

The present invention generally relates to vehicle-mounted note-taking devices. More specifically, the invention relates to a compact and portable dry erase board system designed for use in vehicles, enabling users to easily jot down notes while inside the car. The system comprises a lightweight frame with an erasable writing surface, a rubber sleeve for securely attaching the board to a vehicle's air conditioning vent, and a metal ball joint for adjustable positioning. A threaded cap locks the ball joint in place and a magnetic base enables for easy attachment and removal from the vent. Accordingly, the present disclosure makes specific reference thereto. Nonetheless, it is to be appreciated that aspects of the present invention are also equally applicable to other like applications, devices, and methods of manufacture.

### BACKGROUND

By way of background, many professionals like delivery drivers, truck drivers, and mobile service providers, spend a substantial portion of their workday inside their vehicles. Further, they frequently jot down quick notes such as delivery details, addresses, or customer instructions. However, taking notes in a vehicle presents a challenge due to the lack of a stable, convenient writing surface. Often, individuals have to search for a pen and paper, then struggle to find an appropriate surface to write on. This process is time-consuming, inconvenient, and can result in lost or incomplete information. Traditional note-taking methods, such as using a notepad or smartphone, may also distract drivers and create safety concerns. Furthermore, paper documents or notes can easily get lost or damaged in a cluttered vehicle environment.

Therefore, there exists a long-felt need in the art for a compact and portable note-taking device that can be conveniently used within a vehicle. There is a long-felt need for a device that enables drivers, delivery personnel, and other mobile professionals to quickly jot down notes without having to search for paper or struggle with an uneven surface. Additionally, there is a long-felt need for a note-taking solution that securely mounts within a vehicle. Moreover, there is a long-felt need for a dry erase board that can be easily adjusted, providing different viewing angles for the user depending on their position in the vehicle. Further, there is a long-felt need for a writing solution that reduces paper waste and offers enhanced durability and functionality over traditional paper-based methods. Finally, there is a long-felt need for a note-taking device that enables individuals to record important information while on a phone call.

The subject matter disclosed and claimed herein, in one embodiment, comprises a compact and portable dry erase board device specifically designed for use in vehicles to facilitate note-taking. The device includes a lightweight frame that houses an erasable writing surface and a retaining channel for holding a writing instrument. The device is mounted securely on a vehicle's air conditioning (A/C) vent using a flexible rubber sleeve that slides over the vent slats for providing stability without damaging the vent. A metal ball joint is integrated into the mounting system to enable for rotational and angular adjustments, ensuring that the board can be positioned at the user's preferred viewing angle. A threaded cap locks the ball joint in place to prevent inadvertent movement during use. Additionally, the device features a magnetic base for easy attachment and detachment from the A/C or heater vent.

In this manner, the dry erase board device of the present invention accomplishes all of the foregoing objectives, providing a convenient, secure, and eco-friendly note-taking solution for individuals. The device eliminates the need for paper or traditional notepads and offers a reusable alternative that reduces waste and simplifies note management. The device can be mounted to A/C or heater vent slats and the adjustable ball joint enables users to customize the position of the board for better accessibility while driving or stopped. The device provides professionals, such as delivery drivers or real estate agents, a reliable, stable surface for quick notes, thus improving workflow efficiency and safety while on the road.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a compact and portable dry erase board device for use in a vehicle. The device comprises a frame, an erasable surface disposed within the frame for writing with a writing instrument, a retaining channel positioned in a side arm of the frame for removably holding the writing instrument, a rubber sleeve is attached to a rear surface of the frame, the rubber sleeve is adapted to slide over and securely attach to slats of an air conditioning (A/C) or heater vent in the vehicle. A metal ball is affixed to the rubber sleeve, the metal ball enables rotational and angular adjustment of the erasable surface. A threaded cap is adapted to secure, and lock the metal ball in place, preventing unintentional movement of the erasable surface while driving or writing. A magnetic base is affixed to the rear surface of the frame for mounting the device on the A/C or heater vent.

In another aspect, a dry erase board device for vehicles is disclosed. The device comprises a frame defining a writing surface, wherein the writing surface is replaceable and erasable. A writing instrument is removably held in a retaining channel located on the frame. A rubber sleeve is mounted to a rear surface of the frame, the rubber sleeve is configured to attach to slats of a vehicle air conditioning (A/C) vent. A metal ball is mounted on the rubber sleeve, the metal ball is configured to enable angular adjustments of the writing surface relative to the A/C or heater vent. A threaded cap is positioned around the metal ball for locking the ball in place to maintain the position of the writing surface.

In another embodiment, a method for using a dry erase board device inside a vehicle is disclosed. The method includes the steps of providing a dry erase board device comprising a frame with an erasable surface, a writing instrument, a rubber sleeve, a metal ball, a threaded cap, and a magnetic base, attaching the dry erase board device to slats of a vehicle's air conditioning (A/C) vent by sliding the rubber sleeve over the slats, adjusting the angle of the erasable surface by rotating the frame around the metal ball, locking the metal ball in place using the threaded cap to affix the angle of the erasable surface, writing on the erasable surface using the writing instrument, erasing content from the erasable surface using an eraser on the writing instrument and removing the dry erase board device from the A/C or heater vent by detaching the magnetic base from the rear surface of the frame.

In yet another aspect, the writing instrument further comprises an eraser embedded in the cap of the writing instrument, and the eraser is configured to erase markings made on the erasable surface.

In one embodiment, the device includes an illumination source disposed along an edge of the frame for illuminating the writing surface, a wireless communication module configured to transmit notes written on the writing surface to a paired mobile device, and a power button for activating the illumination source.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of compact and portable dry erase board device of the present invention in accordance with the disclosed structure;

FIG. 2 illustrates a rear perspective view of the compact and portable dry erase board device of the present invention in accordance with the disclosed structure;

FIG. 3 illustrates a flow chart depicting a process of use of the dry erase board device of the present invention in accordance with one embodiment of the disclosed structure;

FIG. 4 illustrates a perspective view showing the dry erase board device of the present invention mounted on an A/C or heater vent of a vehicle in accordance with the disclosed structure;

FIG. 5 illustrates a perspective view showing a user writing on the dry erase board device in accordance with the disclosed structure; and

FIG. 6 illustrates a perspective view of another embodiment of the dry erase board device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a compact and portable note-taking device that can be conveniently used within a vehicle. There is a long-felt need for a device that enables drivers, delivery personnel, and other mobile professionals to quickly jot down notes without having to search for paper or struggle with an uneven surface. Additionally, there is a long-felt need for a note-taking solution that securely mounts within a vehicle. Moreover, there is a long-felt need for a dry erase board that can be easily adjusted, providing different viewing angles for the user depending on their position in the vehicle. Further, there is a long-felt need for a writing solution that reduces paper waste and offers enhanced durability and functionality over traditional paper-based methods. Finally, there is a long-felt need for a note-taking device that enables individuals to presently record important information while on a phone call.

The present invention, in one exemplary embodiment, is a dry erase board device for vehicles. The device comprises a frame defining a writing surface, wherein the writing surface is replaceable and erasable. A writing instrument is removably held in a retaining channel located on the frame. A rubber sleeve is mounted to a rear surface of the frame, the rubber sleeve is configured to attach to slats of a vehicle air conditioning (A/C) vent. A metal ball is mounted on the rubber sleeve, the metal ball is configured to enable angular adjustments of the writing surface relative to the A/C or heater vent. A threaded cap is positioned around the metal ball for locking the ball in place to maintain the position of the writing surface.

Reference will now be made in detail to the present preferred embodiments of the invention, examples of which are illustrated in the accompanying drawings. Wherever possible, the same reference numerals are used in the drawings and the description to refer to the same or like parts.

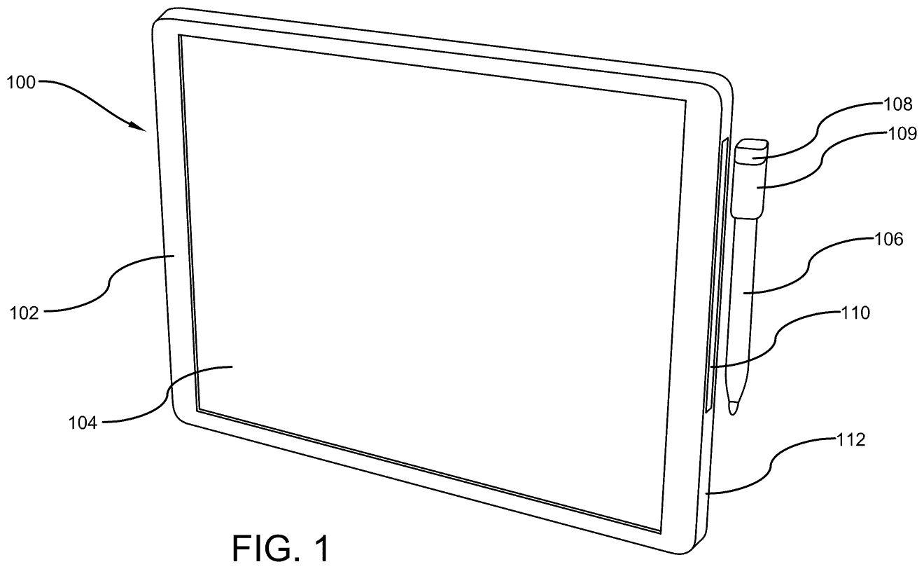

Referring initially to the drawings, FIG. 1 illustrates a front perspective view of compact and portable dry erase board device of the present invention in accordance with the disclosed structure. The compact and portable dry erase board 100 of the present invention is designed specifically for use in a vehicle to enable users for easy note-taking while inside the car. More specifically, the dry erase board 100 is useful for individuals such as delivery drivers, real estate agents, or mobile service providers who need to jot down quick notes while being inside the car. The dry erase board 100 includes a frame 102 which can be made of plastic, wood, metal, or any other durable and lightweight material.

An erasable surface 104 is disposed in the frame 102 and is used for writing using a writing instrument 106 which has an embedded eraser 108 in the cap 109 thereof. The writing instrument 106 is preferably and removably positioned in a retaining channel 110 disposed in a side arm 112 of the frame 102. In the preferred embodiment, the writing instrument 106 is a dry erase marker and helps a user to write down appropriate information on the dry erase board device 100. The erasable surface 104 can be removed and replaced with a new surface 104 as per the preferences of the users.

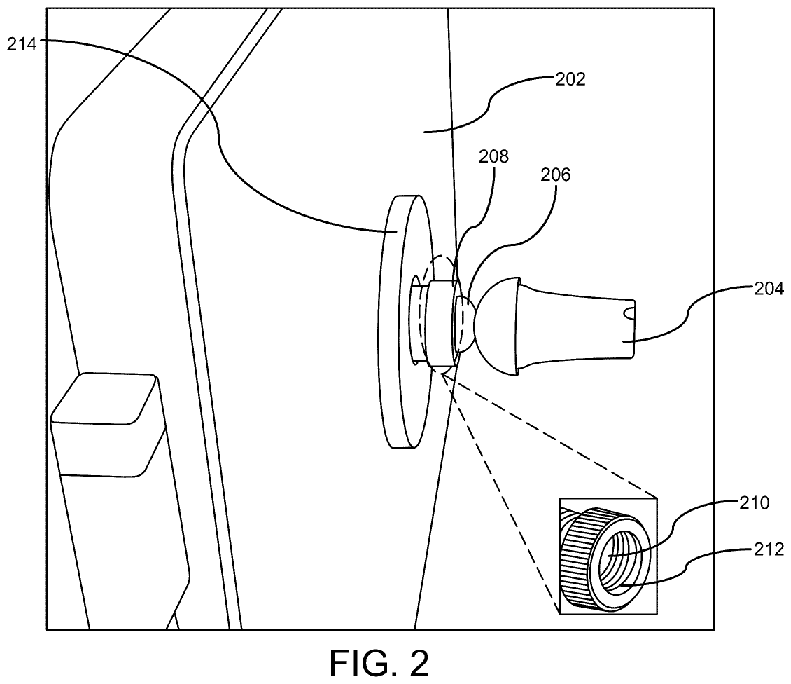

FIG. 2 illustrates a rear perspective view of the compact and portable dry erase board device of the present invention in accordance with the disclosed structure. The rear surface 202 of the device 100 includes a rubber sleeve 204 for removably attaching the device 100 to an A/C or heater vent of a vehicle. The sleeve 204 is designed to slide over the slats of the A/C or heater vent and grips the slats securely to eliminate any unintentional movement to the device 100 while writing on the surface 104. The rubber sleeve 204 is flexible and provides a snug, non-damaging fit on the vent slats.

A metal ball 206 is attached to the rubber sleeve 204 and is adapted to function as a pivot point for adjusting the angle of the device 100 relative to the slats of the A/C or heater vent. The metal ball 206 enables for rotational and angular adjustments of the device 100. A threaded cap 208 securely holds and accommodates the metal ball 206 and includes a threaded opening 210 for securing the metal ball 206. The internal threads 212 of the threaded opening 210 locks the metal ball 206 in place, preventing unintentional movement of the device 100 while driving the vehicle or when a user writes on the erasable surface 104.

A round and strong magnetic base 214 is adapted to be attached to the rear surface 202 of the device 100. The base 214 holds the device 100 and the rubber sleeve 204 to help the device 100 mount easily to the A/C or heater vent slats. The base 214 can be pulled from the surface 202 to remove the holding mechanism as described above for easy storage and transportation of the compact adjustable dry erase board for vehicle use 100.

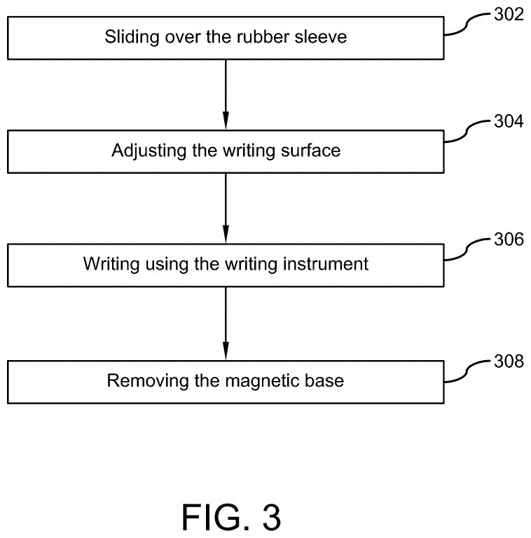

FIG. 3 illustrates a flow chart depicting a process of use of the dry erase board device of the present invention in accordance with one embodiment of the disclosed structure. Initially, rubber sleeve 204 slides over the slats of the vehicle's A/C or heater vent for providing anchor to the device 100 without causing damage to the slats (Step 302). Then, the erasable surface 104 is adjusted by holding and tilting the device 100 to orient the surface 104 in a desirable position for writing on the surface 104 (Step 304). The metal ball 206 enables different positions of the whiteboard 104 at different angles for easy viewing and writing on while driving. Thereafter, the writing instrument 106 is used for writing on the whiteboard 104 (Step 306), and after the use, the surface 104 is rubbed and the magnet base 214 is removed for storing and transporting the device 100 (Step 308).

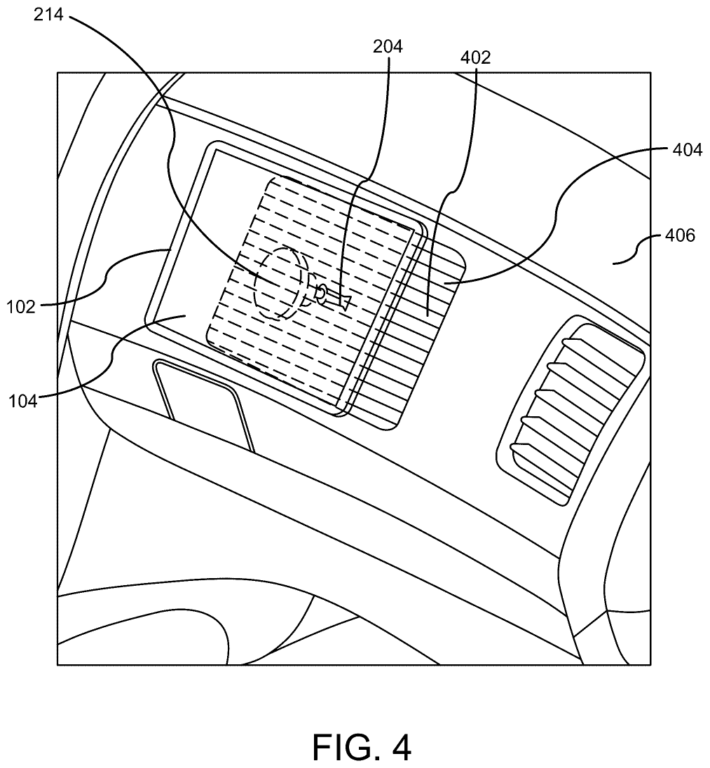

FIG. 4 illustrates a perspective view showing the dry erase board device of the present invention mounted on an A/C or heater vent of a vehicle in accordance with the disclosed structure. As illustrated, the rubber sleeve 204 is engaged with a slat 402 of the A/C or heater vent 404 of the vehicle 406. The rubber sleeve 204 provides a secure engagement for the portable vehicle-mounted dry erase board 100 and the surface 104 is easily accessible to a user for writing using the writing instrument.

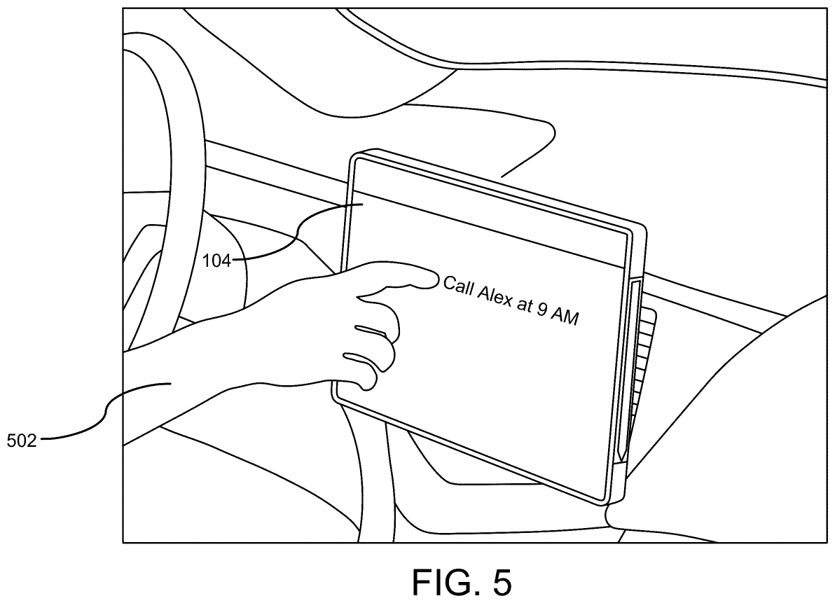

FIG. 5 illustrates a perspective view showing a user writing on the dry erase board device in accordance with the disclosed structure. A user 502 such as a driver or any other passenger can take out the writing instrument 106 from the channel 110 and write on the erasable surface 104. The portable vehicle-mounted dry erase board 100 eliminates the requirement of the user to take out a smartphone or any other digital writing device for making notes, thereby improving safety while driving the vehicle. The device 100 can be mounted on any A/C or heater vent inside the vehicle, enabling multiple users to make notes or even doodle.

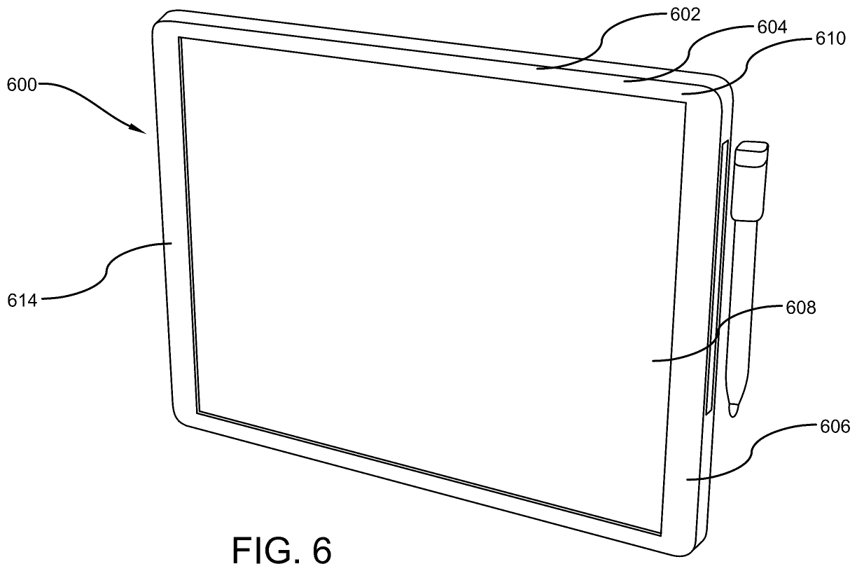

FIG. 6 illustrates a perspective view of another embodiment of the dry erase board device in accordance with the disclosed structure. In the present embodiment, the compact adjustable dry erase board for vehicle use 600 includes an illumination source 602 disposed along the top edge 604 of the frame 606 which is adapted to illuminate the erasable writing surface 608. The illumination source 602 can be activated using a power button 610 and is useful at night or in dark areas, eliminating the user to illuminate the vehicular lights. The notes written by the user on the surface 608 can be automatically sent to a paired smartphone (via a wireless communication module 612) for storage and later review. The smartphone can be paired with the device 600 using Bluetooth or any other pairing technology.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “compact adjustable dry erase board for vehicle use”, “compact and portable dry erase board device”, “portable vehicle-mounted dry erase board”, “dry erase board”, and “device” are interchangeable and refer to the vehicle-mounted dry erase board 100, 600 of the present invention.

Notwithstanding the foregoing, the vehicle-mounted dry erase board 100, 600 of the present invention can be of any suitable size and configuration as is known in the art without affecting the overall concept of the invention, provided that it accomplishes the above-stated objectives. One of ordinary skill in the art will appreciate that the vehicle-mounted dry erase board 100, 600 as shown in the FIGS. are for illustrative purposes only, and that many other sizes and shapes of the vehicle-mounted dry erase board 100, 600 are well within the scope of the present disclosure. Although the dimensions of the vehicle-mounted dry erase board 100, 600 are important design parameters for user convenience, the vehicle-mounted dry erase board 100, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable dry erase board device for use in a vehicle comprising:
a frame having a front surface and a rear surface;
a side arm;
a first erasable writing surface;
a writing instrument;
an eraser;
a cap; and
a retaining channel;
wherein said eraser embedded in said cap;
wherein said front surface of said frame surrounding said first erasable writing surface;
wherein said writing instrument selectively and removably positioned in said retaining channel;
wherein said retaining channel disposed in said side arm of said frame; and
further, wherein said first erasable writing surface selectively replaceable with a second erasable writing surface.

2. The portable dry erase board device for use in a vehicle of claim 1, wherein said rear surface having a rubber sleeve for removably attaching the dry erase board device to an A/C vent of a vehicle.

3. The portable dry erase board device for use in a vehicle of claim 2, wherein said rubber sleeve slidable over at least one of a plurality of slats of said A/C vent.

4. The portable dry erase board device for use in a vehicle of claim 3, wherein said rubber sleeve is flexible.

5. The portable dry erase board device for use in a vehicle of claim 4, wherein said frame surrounding said erasable surface.

6. The portable dry erase board device for use in a vehicle of claim 5, wherein said rubber sleeve having a metal ball attached to said rubber sleeve for pivoting an angle of the dry erase board device.

7. The portable dry erase board device for use in a vehicle of claim 6, wherein said metal ball having a threaded cap for holding said metal ball in a fixed position.

8. The portable dry erase board device for use in a vehicle of claim 7, wherein said threaded cap having a threaded opening for securing and locking said metal ball is said fixed position.

9. The portable dry erase board device for use in a vehicle of claim 8, wherein said frame having a material selected from the group consisting of a plastic, a wood, and a metal.

10. The portable dry erase board device for use in a vehicle of claim 8, wherein said rear surface of said frame having a magnetic base attached thereto, and further wherein said magnetic base holding said rubber sleeve.

11. The portable dry erase board device for use in a vehicle of claim 10, wherein said magnetic base selectively removable from said rear surface.

12. A portable dry erase board device for use in a vehicle comprising:
a frame having a front surface and a rear surface;
a side arm;
a first erasable writing surface;
a writing instrument; and
a retaining channel;
wherein said front surface of said frame surrounding said first erasable writing surface;
wherein said writing instrument selectively and removably positioned in said retaining channel;
wherein said retaining channel disposed in said side arm of said frame; and
further, wherein said first erasable writing surface selectively replaceable with a second erasable writing surface.

13. The portable dry erase board device for use in a vehicle of claim 12, wherein said rear surface having a rubber sleeve for removably attaching the dry erase board device to an A/C vent of a vehicle.

14. The portable dry erase board device for use in a vehicle of claim 13, wherein said rubber sleeve slidable over at least one of a plurality of slats of said A/C vent.

15. The portable dry erase board device for use in a vehicle of claim 14, wherein said rubber sleeve having a metal ball attached to said rubber sleeve for pivoting an angle of the dry erase board device.

16. The portable dry erase board device for use in a vehicle of claim 15, wherein said metal ball having a threaded cap for holding said metal ball in a fixed position.

17. The portable dry erase board device for use in a vehicle of claim 16, wherein said threaded cap having a threaded opening for securing and locking said metal ball is said fixed position.

18. The portable dry erase board device for use in a vehicle of claim 17, wherein said rear surface of said frame having a magnetic base attached thereto, and further wherein said magnetic base holding said rubber sleeve.

19. The portable dry erase board device for use in a vehicle of claim 18 further comprising an illumination source, wherein said frame having said illumination source along at least one edge for selectively illuminating said first erasable writing surface.

20. A portable dry erase board device for use in a vehicle comprising:
a frame having a front surface and a rear surface;
an erasable writing surface;
a writing instrument;
a retaining channel;
a wireless communication module; and
a Bluetooth connection;
wherein said front surface of said frame surrounding said first erasable writing surface;
wherein said writing instrument selectively and removably positioned in said retaining channel;
wherein said rear surface having a rubber sleeve for removably attaching the dry erase board device to an A/C vent of a vehicle;
wherein said rubber sleeve slidable over at least one of a plurality of slats of said A/C vent;
wherein said rubber sleeve having a metal ball attached to said rubber sleeve for pivoting an angle of the dry erase board device; and
further wherein said wireless communication module of the dry erase board device connected via said Bluetooth connection to a smartphone for sending a message from said erasable writing surface of the dry erase board device to the smartphone.
